(19) United States
(12) Patent Application Publication
(10) Pub. No.: US 2008/0154879 A1
(43) Pub. Date: Jun. 26, 2008

(54) Method and apparatus for creating user-generated document feedback to improve search relevancy

(75) Inventor: Steve S. Lin, Menlo Park, CA (US)

Correspondence Address: YAHOO C/O MOFO PALO ALTO, 755 PAGE MILL ROAD, PALO ALTO, CA, 94304, US

(73) Assignee: Yahoo! Inc., Sunnyvale, CA (US)

(21) Appl. No.: 11/644,671

(22) Filed: Dec. 22, 2006

(51) Int. Cl. G06F 17/30

(52) U.S. Cl. 707/5; 707/E17.108

(57) ABSTRACT

Method and system for improving relevancy of online search results are disclosed. The method includes collecting highlighted phrases from users who review one or more documents at one or more websites, aggregating the highlighted phrases about the one or more documents in a distributed hash table, ranking relevancy of the highlighted phrases according to frequency of occurrences of similar phrases, generating search relevancy data to be used by a search relevancy algorithm of a search engine, and generating search results in response to a search query using the search relevancy data.

### FIELD OF THE INVENTION

The present invention relates to the field of Internet applications. In particular, the present invention relates to a method and system for creating user-generated document feedback to improve search relevancy.

### BACKGROUND OF THE INVENTION

In recent years, the Internet has become a main source of information for millions of users. These users rely on the Internet to search for information in their field of interest. One way for users to search for information after reading a document on a webpage is to conduct a search through a search box supported by a search engine. To do so, a user would enter keywords into the search box, and the search engine would generate a search report to the user based on certain statistical analysis of the keywords entered by the user.

In conventional methods for generating search reports, a search engine would employ the techniques of matching keywords and document summary data via a variety of statistical algorithms. These predefined algorithms oftentimes just look at what users in the aggregate would probably think is useful, but do not actually get information from the users that directly maps to what they found useful on that page. For example, such statistical algorithms use contextual information available on the website and use weights determined by anchor links within the webpage to evaluate approximations of the document, closeness of keywords within the document, and the number of links that are propagating back towards the document which also have metadata containing information about the keywords being searched. The conventional methods treat the HTML of a document as a static object. They do not determine whether users interacting with that page find greater relevancy in certain phrases in the document that could actually be used to improve the search.

In other words, while these conventional methods objectively evaluate the search relevancy through predefined statistical algorithms, they have not utilized information about certain keywords and documents provided by users regarding the search relevancy. As a result, many of the search reports generated by conventional search methods fall short of users' expectations in terms of the relevancy of the search results. Therefore, there is a need for a method and system for creating user-generated document feedback to improve search relevancy.

### SUMMARY

The present invention generally relates to a method and system for creating user-generated document feedback to improve search relevancy. The method and system provide users the ability to highlight sections of a webpage and communicate the data to backend servers for processing and aggregating the data in a distributed hash table. The search servers can then use the processed and aggregated search relevancy data to improve the relevancy of search reports in response to users' subsequent search queries.

In one embodiment, a method for improving relevancy of online search results includes collecting highlighted phrases from users who review one or more documents at one or more websites, aggregating the highlighted phrases about the one or more documents in a distributed hash table, ranking relevancy of the highlighted phrases according to frequency of occurrences of similar phrases, generating search relevancy data to be used by a search relevancy algorithm of a search engine, and generating search results in response to a search query using the search relevancy data.

### BRIEF DESCRIPTION OF THE DRAWINGS

The aforementioned features and advantages of the invention, as well as additional features and advantages thereof, will be more clearly understandable after reading detailed descriptions of embodiments of the invention in conjunction with the following drawings.

FIG. 1 illustrates a system for generating search relevancy data according to an embodiment of the present invention.

FIG. 2 illustrates a distributed hash table for aggregating search relevancy data according to an embodiment of the present invention.

FIG. 3 illustrates a method for using search relevancy data to improve the relevancy of a search report according to an embodiment of the present invention.

Like numbers are used throughout the figures.

### DESCRIPTION OF EMBODIMENTS

Methods and systems are provided for creating user-generated document feedback to improve search relevancy. The following descriptions are presented to enable any person skilled in the art to make and use the invention. Descriptions of specific embodiments and applications are provided only as examples. Various modifications and combinations of the examples described herein will be readily apparent to those skilled in the art, and the general principles defined herein may be applied to other examples and applications without departing from the spirit and scope of the invention. Thus, the present invention is not intended to be limited to the examples described and shown, but is to be accorded the widest scope consistent with the principles and features disclosed herein.

Some portions of the detailed description that follows are presented in terms of flowcharts, logic blocks, and other symbolic representations of operations on information that can be performed on a computer system. A procedure, computer-executed step, logic block, process, etc., is here conceived to be a self-consistent sequence of one or more steps or instructions leading to a desired result. The steps are those utilizing physical manipulations of physical quantities. These quantities can take the form of electrical, magnetic, or radio signals capable of being stored, transferred, combined, compared, and otherwise manipulated in a computer system. These signals may be referred to at times as bits, values, elements, symbols, characters, terms, numbers, or the like. Each step may be performed by hardware, software, firmware, or combinations thereof.

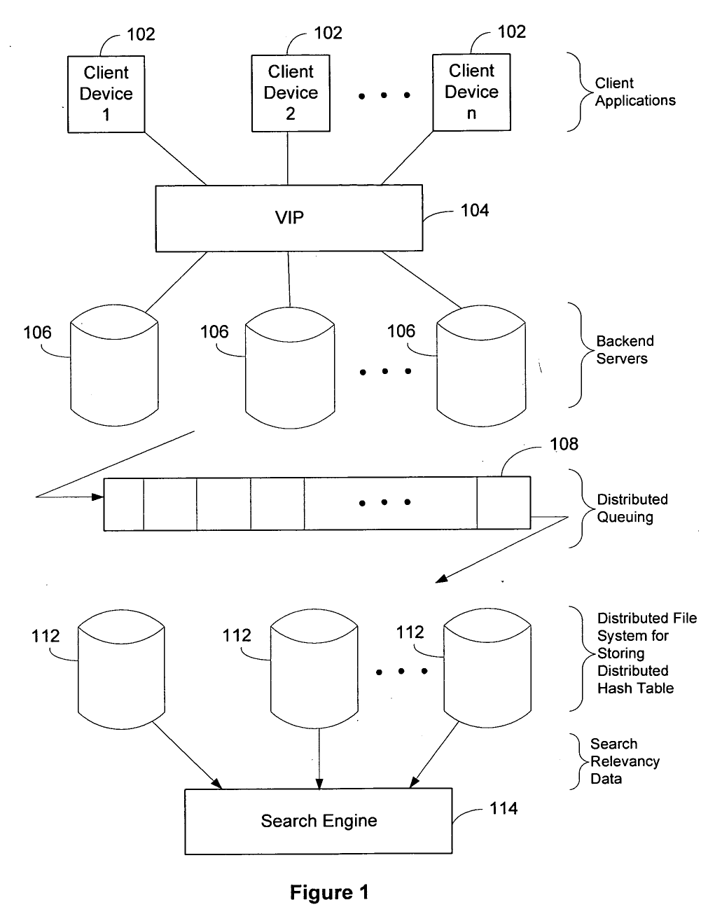

FIG. 1 illustrates a system for generating search relevancy data according to an embodiment of the present invention. In one embodiment, the system provides a solution to collect search relevancy data based on the fact that users often highlight sections of text while scanning critical sections of a website. In one approach, a client application is placed on a client device 102 to perform reporting of highlighting activities when a user visits a website. The client application may be implemented as a browser plug-in or application in ActiveX, such as the Yahoo Toolbar or Y! Q in the browser. In other embodiments, such function of monitoring and reporting a user's highlighting activities may be performed by a widget type of application on the client device.

When the user highlights phrases (also referred to as keywords) of a document on a webpage, the client application dispatches that data to a cluster of backend servers 106 for processing through a virtual Internet Protocol load balancer (VIP) 104. The data communicated from a client device to the backend servers may include a client ID, a URI of the document, highlighted phrases, etc. The VIP serves as a front-end interface for the set of search backend servers. It performs load-balancing requests from client devices to the cluster of backend servers 106 running behind the VIP load-balancer, where IP means the Internet Protocol address of a machine.

The set of backend servers 106 handle the messaging protocol and ensure the validity of the client and the message. Then, the backend servers perform the writing of the information to a distributed file system that stores the information. The distributed file system consists of a group of servers 112 for storing a distributed hash table. The distributed file system controls accessing to the distributed hash table, including accessing each row, and handling row-level locking on a particular page. In one implementation, a centralized queuing mechanism/cache 108 is employed, to which each of the backend servers writes. Then data stored in the centralized queuing cache is processed and written offline to the distributed hash table in the distributed file system. In this manner, the requests by the backend servers to write information to the distributed hash table are handled faster. The data stored in the distributed hash table is then fed in to a search relevancy algorithm of the search engine 114 to improve relevancy of search reports generated by the search engine.

Note that the highlighted phrases are user-generated content as the users review documents on a website. In this example, the users use highlighting as they would normally do when they read a book. The highlighting gives them a quick summary of what the document is about. The mechanism is similar to adding user-created metadata to the document. The disclosed method uses such highlighted information and its corresponding metadata to promote the relevancy of the highlighted terms to the document. In other embodiments, a tag may be used in place of the highlighting.

In one embodiment, the backend servers 106 communicate with the client devices 102 via the Simple Object Access Protocol (SOAP). SOAP is a protocol for exchanging XML-based messages over a computer network, typically using HTTP. SOAP forms the foundation layer of the web services stack, providing a basic messaging framework that more abstract layers can build on. In SOAP, one network node (the client) sends a request message to another node (the server), and the server immediately sends a response message to the client. The following is an example of how a client may format a SOAP message requesting information about product (ID 827635) from a warehouse web service.

```
<soap:Envelope
xmlns:soap=“http://schemas.xmlsoap.org/soap/envelope/”>
  <soap:Body>
    <getProductDetails xmlns=“http://warehouse.example.com/ws”>
      <productID>827635</productID>
    </getProductDetails>
  </soap:Body>
</soap:Envelope>
```

Here is an example of the web service page that would provide the response for the client request above.

```
<soap:Envelope
xmlns:soap=“http://schemas.xmlsoap.org/soap/envelope/”>
  <soap:Body>
    <getProductDetailsResponse
    xmlns=“http://warehouse.example.com/ws”>
      <getProductDetailsResult>
        <productName>Toptimate 3-Piece Set</productName>
        <productID>827635</productID>
        <description>3-Piece luggage set. Black Polyester.</description>
        <price>96.50</price>
        <inStock>true</inStock>
      </getProductDetailsResult>
    </getProductDetailsResponse>
  </soap:Body>
</soap:Envelope>
```

Note that in other embodiments, the dispatched data may be encrypted for security purposes. A shared secret is a key that both parties in the communication are aware of. For example, a client device 102 encodes a secret with the data to be transmitted, and a backend server 106 decodes the received data with the secret. The secret is used to ensure that a client device and a backend server are communicating with each other intentionally and the transmitted data is properly protected.

In addition, to avoid duplicate information received from the same client device that may cause overweighting of certain highlighted phrases within the system, the client application may submit a client install identifier, which may be generated at install time via a one-way hash of the media access control (MAC) address and a shared secret between the client device and the backend servers. The backend servers may then aggregate the highlighted phrases and their corresponding uniform resource identifiers (URIs) in a distributed hash table.

In embodiments of the present invention, a distributed file system is used to store the distributed hash table that aggregates users' feedback of keywords of documents they viewed. A distributed file system (DFS) is a file system whose clients, servers, and storage devices are dispersed among the machines of a distributed system or intranet. Accordingly, service activity has to be carried out across the network, and instead of a single centralized data repository, the system has multiple and independent storage devices. The configuration and implementation of a DFS may vary. In some configurations, servers run on dedicated machines, while in others a machine can be both a server and a client. A DFS can be implemented as part of a distributed operating system, or alternatively, by a software layer whose task is to manage the communication between conventional operating systems and file systems. The distinctive features of a DFS are the multiplicity and autonomy of clients and servers in the system.

In a DFS, a file server provides file services to clients. A client interface for a file service is formed by a set of primitive file operations, such as creating a file, deleting a file, reading from a file, and writing to a file. The primary hardware component that a file server controls is a set of local secondary-storage devices on which files are stored, and from which they are retrieved according to the client requests.

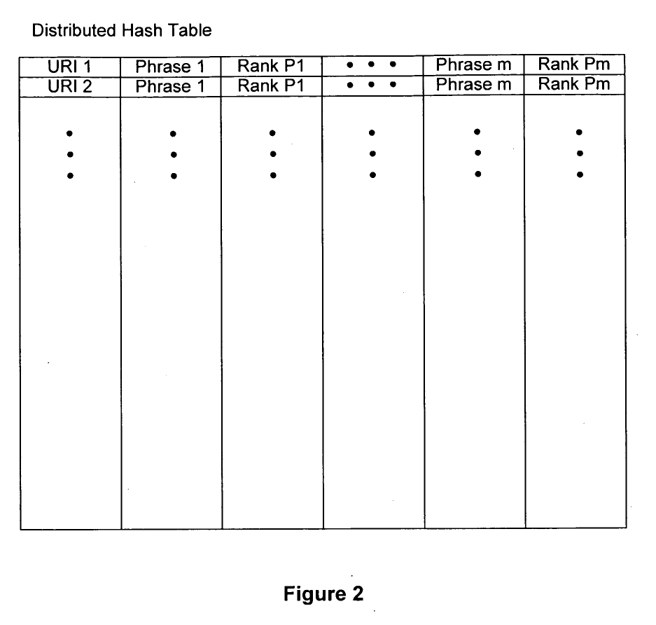

FIG. 2 illustrates a distributed hash table for aggregating search relevancy data according to an embodiment of the present invention. As shown in FIG. 2, a distributed hash table includes a plurality of URIs for identifying the websites where information is collected. Each row of the distributed hash table corresponds to one URI. Within each row, the distributed hash table may include one or more phrases collected from that URI and a corresponding rank value indicating the number of times (frequency) that a phrase has been highlighted.

A URI is a compact string of characters used to identify or name a resource. The main purpose of this identification is to enable interaction with representations of the resource over a network, typically the World Wide Web, using specific protocols. A URI can be classified as a locator or a name or both. A Uniform Resource Locator (URL) is a URI that, in addition to identifying a resource, provides a means of acting upon or obtaining a representation of the resource by describing its primary access mechanism or network “location.” A Uniform Resource Name (URN) is a URI that identifies a resource by name in a particular namespace. A URN can be used to describe a resource without implying its location or how to dereference it. For example, the URN urn:isbn:0-395-36341-1 is a URI that, like an International Standard Book Number (ISBN), allows one to describe a book, but doesn't suggest where and how to obtain an actual copy of it.

As shown in FIG. 2, a distributed hash table is used to aggregate search relevancy data for subsequent consumption by a search relevancy algorithm of the search engine. The highlighted phrases are added to the distributed hash table as part of the weighted average against the other highlighted phrases. Then, the overall rank of the phrases would shift the search relevancy algorithm so that it would take into account the ranking provided by the distributed hash table. Distributed hash tables (DHTs) are a class of decentralized distributed systems that partition ownership of a set of keys among participating nodes, and can efficiently route messages to the unique owner of any given key. Each node is analogous to an array slot in a hash table. DHTs are typically designed to scale to large numbers of nodes and to handle continual node arrivals and failures. This infrastructure can be used to build more complex services, such as distributed file systems, peer-to-peer file sharing systems, cooperative web caching, multicast, anycast, domain name services, and instant messaging.

There are different ways a server may find the data its peers hold. In a central index server model, each node, upon joining, would send a list of locally held files to the server, which would perform searches and refer the user to the nodes that held the results. This central component left the system vulnerable to attacks. In a flooding query model, each search would result in a message being broadcast to every other machine in the network. While avoiding a single point of failure, this method was significantly less efficient than the central index server model. A distributed model employs a heuristic key-based routing in which each file is associated with a key, and files with similar keys tend to cluster on a similar set of nodes. Queries are likely to be routed through the network to such a cluster without needing to visit many peers. However, the distributed model does not guarantee that data may be found.

Distributed hash tables use a more structured key-based routing in order to attain both the decentralization of the flooding query model and the distributed model, and the efficiency and guaranteed results of the central index server model. DHTs have the following properties:
Decentralization: the nodes collectively form the system without any central coordination.
Scalability: the system should function efficiently even with thousands or millions of nodes.
Fault tolerance: the system should be reliable (in some sense) even with nodes continuously joining, leaving, and failing.

A DHT is built around an abstract keyspace, such as the set of 160-bit strings. Ownership of the keyspace is split among the participating nodes according to a keyspace partitioning scheme. The overlay network connects the nodes, allowing them to find the owner of any given key in the keyspace.

Once these components are in place, a typical use of the DHT for storage and retrieval is as follows. Suppose the keyspace is the set of 160-bit strings; to store a file with given filename and data in the DHT, the hash of filename is found, producing a 160-bit key k. Thereafter, a message put(k,data) may be sent to any node participating in the DHT. The message is forwarded from node to node through the overlay network until it reaches the single node responsible for key k as specified by the keyspace partitioning, where the pair(k,data) is stored. Any other client can then retrieve the contents of the file by again hashing filename to produce k and asking any DHT node to find the data associated with k with a message get(k). The message will again be routed through the overlay to the node responsible for k, which will reply with the stored data.

In this example, the relevancy of a phrase is determined by analyzing the context of the phrase. The rank (also known as the reference count) is used to keep track of the number of times similar phrases have been highlighted. These reference counts then serve as relevancy metrics for the keywords and phrases. The rank of a phrase is incremented or promoted if it is determined that the phrase already exists in the distributed hash table. If it is determined that a phrase is not in the distributed hash table, it is then added to the distributed hash table. Keywords and phrases highlighted with higher counts would be ranked above keywords and summaries identified to be associated with the webpage through traditional methods. Note that phrases having low frequency count may be pruned from the distributed hash table according to a predetermined threshold of frequency counts during a predetermined period of time. For example, if a phrase has a frequency count of less than five in a period of three months, this phase may be pruned from the distributed hash table.

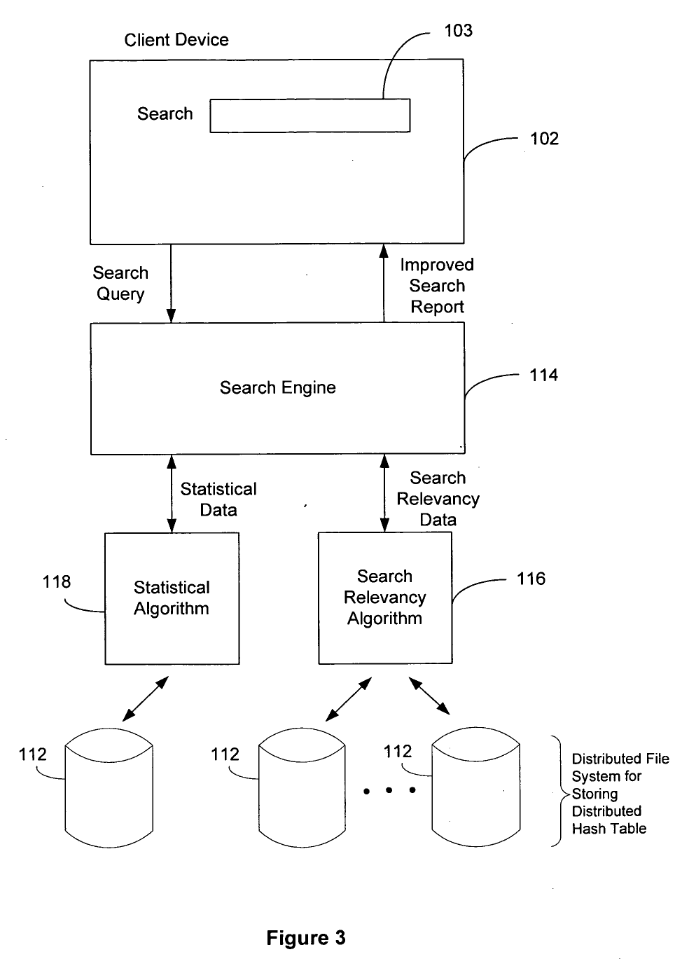

FIG. 3 illustrates a method for using search relevancy data to improve the relevancy of a search report according to an embodiment of the present invention. In this example, a user submits a search query from a search box 103 of a client device 102 to a search engine 114. The search engine conducts searches of databases 112 through a search relevancy algorithm 116 and a statistical algorithm 118. The search relevancy algorithm provides search relevancy data to the search engine, while the statistical algorithm provides statistical data to the search engine. With the addition of the search relevancy data, the search engine is able to weigh the search relevancy data against the statistical data. In other words, the search relevancy data supplements the statistical data for enabling the search engine to produce an improved search report to the user. In other embodiments, the search engine may use only the search relevancy data or may use the search relevancy data in combination with other sources of data to produce the search report.

In some embodiments of the present invention, the statistical algorithm may implement the PageRank algorithm. The PageRank algorithm is a link analysis algorithm that assigns a numerical weighting to each element of a hyperlinked set of documents, such as the World Wide Web, with the purpose of “measuring” its relative importance within the set. The algorithm may be applied to any collection of entities with reciprocal quotations and references. The numerical weight that it assigns to any given element E is also called the PageRank of E and denoted by PR(E).

PageRank is a probability distribution used to represent the likelihood that a person randomly clicking on links will arrive at any particular page. PageRank can be calculated for any-size collection of documents. It is assumed in several research papers that the distribution is evenly divided between all documents in the collection at the beginning of the computational process. The PageRank computations require several passes, called “iterations,” through the collection to adjust approximate PageRank values to more closely reflect the theoretical true value. A probability is expressed as a numeric value between 0 and 1. A 0.5 probability is commonly expressed as a “50% chance” of something happening. Hence, a PageRank of 0.5 means there is a 50% chance that a person clicking on a random link will be directed to the document with the 0.5 PageRank. A simplified PageRank algorithm is described below.

Suppose a small universe of four web pages: A, B, C, and D. The initial approximation of PageRank would be evenly divided between these four documents. Hence, each document would begin with an estimated PageRank of 0.25.

If pages B, C, and D each only link to A, they would each confer 0.25 PageRank to A. All PageRank PR( ) in this simplistic system would thus gather to A because all links would be pointing to A.

PR(A)=PR(B)+PR(C)+PR(D)

But then suppose page B also has a link to page C, and page D has links to all three pages. The value of the link-votes is divided among all the outbound links on a page. Thus, page B gives a vote worth 0.125 to page A and a vote worth 0.125 to page C. Only one third of D's PageRank is counted for A's PageRank (approximately 0.081).

PR(A)=PR(B)/2+PR(C)/1+PR(D)/3

In other words, the PageRank conferred by an outbound link L( ) is equal to the document's own PageRank score divided by the normalized number of outbound links (it is assumed that links to specific URLs only count once per document).

PR(A)=PR (B)/L(B)+PR (C)/L(C)+PR (D)/L(D)

In some applications, the search report generated using search relevancy data aggregated from users' feedback is more accurate than the conventional search method of using statistical data produced by contextual analysis of a document on a website. This is because if the search engine merely performs a crawl as in the conventional search method, it may not understand the meaning of the document versus a user who actually reads the document and understands some key sections and highlights those key sections of the document. Therefore, it is preferable to give a greater weight to the search relevancy data than to the statistical data produced by a statistical algorithm such as the PageRank algorithm.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processors or controllers. Hence, references to specific functional units are to be seen as references to suitable means for providing the described functionality rather than indicative of a strict logical or physical structure or organization.

The invention can be implemented in any suitable form, including hardware, software, firmware, or any combination of these. The invention may optionally be implemented partly as computer software running on one or more data processors and/or digital signal processors. The elements and components of an embodiment of the invention may be physically, functionally, and logically implemented in any suitable way. Indeed, the functionality may be implemented in a single unit, in a plurality of units, or as part of other functional units. As such, the invention may be implemented in a single unit or may be physically and functionally distributed between different units and processors.

One skilled in the relevant art will recognize that many possible modifications and combinations of the disclosed embodiments may be used, while still employing the same basic underlying mechanisms and methodologies. The foregoing description, for purposes of explanation, has been written with references to specific embodiments. However, the illustrative discussions above are not intended to be exhaustive or to limit the invention to the precise forms disclosed. Many modifications and variations are possible in view of the above teachings. The embodiments were chosen and described to explain the principles of the invention and their practical applications, and to enable others skilled in the art to best utilize the invention and various embodiments with various modifications as suited to the particular use contemplated.

What is claimed is:

1. A method for improving relevancy of online search results, comprising:
collecting highlighted phrases from users who review one or more documents at one or more websites;
aggregating the highlighted phrases about the one or more documents in a distributed hash table;
ranking relevancy of the highlighted phrases according to frequency of occurrences of similar phrases;
generating search relevancy data to be used by a search relevancy algorithm of a search engine; and
generating search results in response to a search query using the search relevancy data.

2. The method of claim 1, wherein collecting highlighted phrases comprises:
installing a client application at a plurality of user devices;
monitoring users' activities while viewing the one or more documents at the one or more websites;
retrieving highlighted phrases and their corresponding metadata;
sending the highlighted phrases and their corresponding metadata to a set of servers for processing and storage.

3. The method of claim 2 further comprising:
sending client identifiers and universal resources indicators of the documents to the set of servers for processing and storage.

4. The method of claim 1, wherein an entry to the distributed hash table comprises:
a universal resource indicator;
one or more highlighted phrases collected from the plurality of users; and
a rank of relevancy for each of the highlighted phrases according to a count of number of times the phrase being highlighted.

5. The method of claim 1, wherein aggregating the highlighted phrases comprises:
determining whether a similar highlighted phrase already exists in the distributed hash table; and
incrementing a count of number of times the highlighted phrase in response to the highlighted phrase already exists in the distributed hash table.

6. The method of claim 5, wherein aggregating the highlighted phrases further comprises:
pruning phrases having low frequency count from the distributed hash table according to a predetermined threshold of frequency counts during a predetermined period of time.

7. The method of claim 1, wherein aggregating the highlighted phrases comprises:
determining whether a similar highlighted phrase already exists in the distributed hash table; and
adding the highlighted phrase to the distributed hash table in response to the highlighted phrase not being found in the distributed hash table.

8. The method of claim 1, wherein ranking relevancy of the highlighted phrases comprises:
promoting relevancy of a phrase in accordance with its corresponding frequency of occurrence in the distributed hash table.

9. A computer program product for improving relevancy of online search results, comprising a medium storing computer programs for execution by one or more computer systems, the computer program product comprising:
code for collecting highlighted phrases from users who review one or more documents at one or more websites;
code for aggregating the highlighted phrases about the one or more documents in a distributed hash table;
code for ranking relevancy of the highlighted phrases according to frequency of occurrences of similar phrases;
code for generating search relevancy data to be used by a search relevancy algorithm of a search engine; and
code for generating search results in response to a search query using the search relevancy data.

10. The computer program product of claim 9, wherein the code for collecting highlighted phrases comprises:
code for installing a client application at a plurality of user devices;
code for monitoring users' activities while viewing the one or more documents at the one or more websites;
code for retrieving highlighted phrases and their corresponding metadata;
code for sending the highlighted phrases and their corresponding metadata to a set of servers for processing and storage.

11. The computer program product of claim 10 further comprising:
code for sending client identifiers and universal resources indicators of the documents to the set of servers for processing and storage.

12. The computer program product of claim 9, wherein an entry to the distributed hash table comprises:
a universal resource indicator;
one or more highlighted phrases collected from the plurality of users; and
a rank of relevancy for each of the highlighted phrases according to a count of number of times the phrase being highlighted.

13. The computer program product of claim 9, wherein the code for aggregating the highlighted phrases comprises:
code for determining whether a similar highlighted phrase already exists in the distributed hash table; and
code for incrementing a count of number of times the highlighted phrase in response to the highlighted phrase already exists in the distributed hash table.

14. The computer program product of claim 13, wherein the code for aggregating the highlighted phrases further comprises:
code for pruning phrases having low frequency count from the distributed hash table according to a predetermined threshold of frequency counts during a predetermined period of time.

15. The computer program product of claim 9, wherein the code for aggregating the highlighted phrases comprises:
code for determining whether a similar highlighted phrase already exists in the distributed hash table; and
code for adding the highlighted phrase to the distributed hash table in response to the highlighted phrase not being found in the distributed hash table.

16. The computer program product of claim 9, wherein the code for ranking relevancy of the highlighted phrases comprises:
code for promoting relevancy of a phrase in accordance with its corresponding frequency of occurrence in the distributed hash table.
